(19) United States
(12) Patent Application Publication
(10) Pub. No.: US 2021/0297893 A1
(43) Pub. Date: Sep. 23, 2021

(54) Method and Network Nodes for Handling End-to-End Delays for Voice Calls in a Communication Network

(71) Applicant: Telefonaktiebolaget LM Ericsson (publ), Stockholm (SE)

(72) Inventor: Magnus Hallenstål, Täby (SE)

(21) Appl. No.: 17/257,460

(22) PCT Filed: Jul. 10, 2018
(86) PCT No.: PCT/SE2018/050756

§ 371 Date: Dec. 31, 2020

(51) Int. Cl. H04W 28/02; H04W 80/04; H04L 29/06; H04W 24/08; H04L 12/26

(52) U.S. Cl. CPC H04W 28/0268; H04W 80/04; H04L 43/0852; H04W 24/08; H04L 65/608

(57) ABSTRACT

The embodiments herein relate to a method, performed by an IMS core network node (140), for handling end-to-end, E2E, delays for voice calls in a communication network (100). The communication network (100) comprises a packet core network node (130), the IMS core network node (140) and a radio network node (110). The radio network node (110) is serving one or more UEs (120). The IMS core network node (140) obtains a Packet Delay Budget, PDB, for the IMS core network node (140). The IMS core network node (140) estimates a packet delay related to a first voice call, wherein the packet delay is caused by the IMS core network. The IMS core network node (140) determines a PDB for a packet core network node (130) related to the first voice call, taking the estimated packet delay caused by the IMS core network into account. The IMS core network node (140) provides, to the packet core network node (130), the determined PDB for the packet core network node (130). The embodiments herein further relate to corresponding methods, performed by the packet core network node (130) and the radio network node (110).

### TECHNICAL FIELD

Embodiments herein relate to a method and network nodes for handling end-to-end delays for voice calls in a communication network.

### BACKGROUND

In current Voice over Long Term Evolution (VoLTE) system, a system requirement for mouth to ear delay for voice is set to 225 milliseconds (ms), i.e. from mouth of a user using a sending user device to an ear of a user using a receiving user device. The Long Term Evolution (LTE) access assumes that 80 ms delay for a voice call is allowed over the radio interface, which may herein also be referred to as the Radio Access Network (RAN). For an End-to-End (E2E) VoLTE call, such as for example from a first user device to a second user device, this means a 160 ms delay for the radio interface and that 65 ms delay remains for packet core network delays, internal terminal processing delays including jitter buffer, inter/intra operator voice interconnect delays and transport delays. Jitter buffer is a data area where voice packets may be collected, stored, and sent to a voice processor in evenly spaced intervals. Variations in packet arrival time, which may be referred to as jitter, may occur because of network congestion, timing drift, or route changes related to the packet. The jitter buffer, which may be located at the receiving end of a voice connection, intentionally delays the arriving packets so that an end user experiences a clear connection with very little sound distortion. Jitter buffers may sometimes be needed at transcoding points in the network. These transcoding points change the codec used. For example AMR codec to G.711 codec. Jitter buffers may be used in the communication network if packet transport to circuit transport is done.

The E2E delay may also be referred to as a mouth-to-ear delay, i.e. the time it takes for a speech signal to go from the mouth of a first user speaking to the ear of a second user listening. At mouth-to-ear delays above 200 ms the user starts to experience a Quality of Service (QoS) degradation for the voice service, at 225 ms, the rate of degradation of the experienced voice quality drastically increases, and at delays of 300 ms some users are dissatisfied. Thus, for voice calls the E2E delay should be kept below 300 ms, and in order to have a high QoS for the voice call the delay should not be more than 225 ms.

### SUMMARY

Existing solutions do not take the transmission delays and inter/intra operator interconnect delays that may be expected into account when calculating the E2E delay for a voice call.

Hence, embodiments herein aim to provide a solution for improving voice quality and providing more flexibility in scheduling of voice calls over the radio interface.

According to a first aspect of embodiments herein, the object is achieved by a method, performed by an IP Multimedia Subsystem (IMS) core network node, for handling end-to-end (E2E) delays for voice calls in a communication network. The communication network comprises a packet core network node, the IMS core network node and a radio network node. The radio network node is serving one or more User Equipment (UE)s. The IMS core network node obtains a Packet Delay Budget (PDB) for the IMS core network node 140. The IMS core network node estimates a packet delay related to a first voice call, wherein the packet delay is caused by the IMS core network. The IMS core network node determines a packet delay budget for a packet core network node related to the first voice call, taking the estimated packet delay caused by the IMS core network into account. The IMS core network node provides the determined PDB for the packet core network node to the packet core network node.

According to a second aspect of embodiments herein, the object is achieved by a method, performed by a packet core network node, for handling E2E delays for voice calls in a communication network. The communication network comprises the packet core network node, the IMS core network node and the radio network node. The radio network node is serving one or more UEs. The packet core network node obtains, from the IMS core network node, a PDB for the packet core network node, wherein the packet delay relates to a first voice call. The packet core network node estimates a packet delay related to a first voice call, wherein the packet delay is caused by the packet core network. The packet core network node determines a packet delay budget for the radio network node, wherein the PDB is related to the first voice call, taking the estimated packet delay caused by the packet core network into account. The packet core network node provides the determined packet delay budget for the radio network node to the radio network node.

According to a third aspect of embodiments herein, the object is achieved by a method performed by a radio network node, for handling E2E delays for voice calls in a communication network. The communication network comprises the packet core network, the IMS core network node and the radio network node. The radio network node is serving one or more UEs. The radio network node obtains a PDB for the radio network node, wherein the PDB is related to a first voice call associated with a first UE of the one or more UEs. The packet delay budget takes packet delays caused by the core network 13, 14 into account. The radio network nod schedules the first voice call based on the obtained indication of the PDB associated with the first voice call.

According to a fourth aspect of embodiments herein, the object is achieved by an IMS core network node, for handling E2E delays for voice calls in a communication network. The communication network comprises the packet core network node, the IMS core network node and the radio network node. The radio network node is serving one or more UEs. The IMS core network node is configured to obtain a PDB for the IMS core network node. The IMS core network node is configured to estimate a packet delay related to a first voice call, wherein the packet delay is caused by the IMS core network. The IMS core network node is configured to determine a PDB for a packet core network node related to the first voice call, taking the estimated packet delay caused by the IMS core network into account. The IMS core network node is configured to provide the determined PDB for the packet core network node to the packet core network node.

According to a fifth aspect of embodiments herein, the object is achieved by a packet core network node, for handling E2E delays for voice calls in a communication network. The communication network comprises the packet core network node, the IMS core network node and the radio network node. The radio network node is serving one or more UEs. The packet core network node is configured to obtain, from the IMS core network node, a PDB for the packet core network node, wherein the packet delay relates to a first voice call. The packet core network node is configured to estimate a packet delay related to a first voice call, wherein the packet delay is caused by the packet core network. The packet core network node is configured to determine a PDB for the radio network node, wherein the PDB is related to the first voice call, taking the estimated packet delay caused by the packet core network into account. The packet core network node is configured to provide the determined PDB for the radio network node to the radio network node.

According to a sixth aspect of embodiments herein, the object is achieved by a radio network node, for handling E2E delays for voice calls in a communication network. The communication network comprises the packet core network node, the IMS core network node and the radio network node. The radio network node is serving one or more UEs. The radio network node is configured to obtain a PBD for the radio network node, wherein the PDB is related to a first voice call associated with a first UE of the one or more UEs. The PDB takes packet delays caused by the core network into account. The radio network node is configured to schedule the first voice call based on the obtained indication of the packet delay budget associated with the first voice call.

According to a seventh aspect of embodiments herein, the object is achieved by a computer program product comprising instructions, which, when executed on at least one processor, cause the at least one processor to carry out the method according to the embodiments herein.

According to an eight aspect of embodiments herein, the object is achieved by a computer-readable storage medium, having stored thereon a computer program product comprising instructions which, when executed on at least one processor, cause the at least one processor to carry out the method according to the embodiments herein.

By determining the PDB for the radio network node taking the packet delays caused by the core networks into account enables the radio network node to adjust the scheduling of the voice calls in a more flexible manner and also provides an ability to adjust the delay in the radio interface on a per call basis. Since the PDB for the RAN is determined for each voice call instead of using an assumed fixed value for all voice calls as in the legacy networks, the voice calls can be scheduled in a more flexible manner.

By allowing higher packet delays in the RAN, which may herein also be referred to as the radio interface, for calls where the packet delay in the core network is low, such as e.g. close to 0 ms, and smaller packet delays for calls where the packet delay in the core network is significant, the scheduling of calls over the radio interface may be adjusted so that the E2E delay for each call is below a predefined threshold. The embodiments herein thus improve quality of the voice calls and provides more flexibility in scheduling voice calls, which may also be referred to as voice bearers, over the radio interface.

### BRIEF DESCRIPTION OF THE DRAWINGS

FIG. 1 is a schematic block diagram illustrating embodiments of a wireless communications network;

FIG. 2 is a schematic block diagram illustrating embodiments of an IMS core network;

FIG. 3 is a schematic block diagram illustrating packet delays occurring in the wireless communications network;

FIG. 4 is a schematic block diagram illustrating packet delay budgets for various parts of the wireless communications network;

FIG. 5 is a flowchart illustrating the setup of an E2E call according to embodiments herein;

FIG. 6 is a flowchart illustrating a method performed by an IMS core network node;

FIG. 7 is a flowchart illustrating a method performed by a packet core network node;

FIG. 8 is a flowchart illustrating a method performed by a radio network node;

FIG. 9 is a schematic block diagram illustrating some first embodiments of an IMS core network node;

FIG. 10 is a schematic block diagram illustrating some second embodiments of the IMS core network node;

FIG. 11 is a schematic block diagram illustrating some first embodiments of a packet core network node;

FIG. 12 is a schematic block diagram illustrating some second embodiments of the packet core network node;

FIG. 13 is a schematic block diagram illustrating some first embodiments of a radio network node;

FIG. 14 is a schematic block diagram illustrating some second embodiments of the radio network node;

FIG. 15 is a schematic overview of a telecommunication network connected via an intermediate network to a host computer in accordance with some embodiments;

FIG. 16 is a schematic overview of a host computer communicating via a base station with a user equipment over a partially wireless connection in accordance with some embodiments;

FIG. 17 is a flowchart depicting methods implemented in a communication system including a host computer, a base station and a user equipment in accordance with some embodiments;

FIG. 18 is a flowchart depicting methods implemented in a communication system including a host computer, a base station and a user equipment in accordance with some embodiments;

FIG. 19 is a flowchart depicting methods implemented in a communication system including a host computer, a base station and a user equipment in accordance with some embodiments;

FIG. 20 is a flowchart depicting methods implemented in a communication system including a host computer, a base station and a user equipment in accordance with some embodiments.

### DETAILED DESCRIPTION

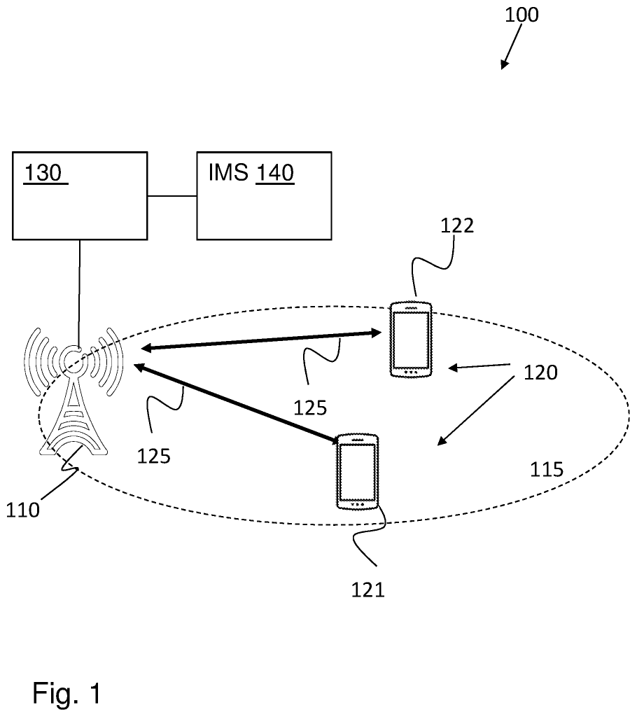

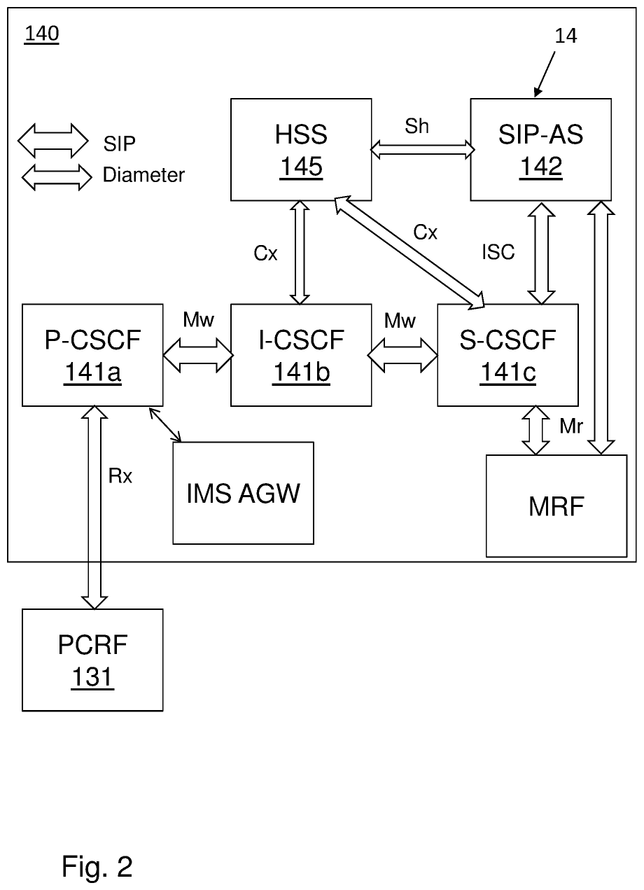

FIG. 1 is a block diagram illustrating an example wireless communication network, in which the embodiments herein may be implemented. The wireless communications network 100 comprises one or more UEs 120, such as a first UE 121 and a second UE 122. The UEs 120 may e.g. be mobile phones, smart phones, laptop computers, tablet computers, Machine-Type Communication (MTC) devices, mobile stations, stations (STA), or any other devices that can provide wireless communication and thus may also be referred to as a wireless device. The UE 120 may communicate via the wireless communication network, such as a Local Area Network (LAN), such as e.g. a Wi-Fi network, or a Radio Access Network (RAN) to one or more core networks (CN) 13, 14, such as e.g. an Evolved Packet Core (EPC) or a 5^{th} Generation Core (5GC). The wireless communication network further comprises a radio network node 110, such as e.g. a radio access node e.g., a Wi-Fi access point or a radio base station (RBS), which in some networks may also be denoted, for example, a NodeB, eNodeB (eNB), or gNodeB (gNB) as denoted in New Radio (NR). NR may also be referred to as 5th-Generation Wireless Systems (5G) radio. The radio network node 110 serves a coverage area 115, which may also be referred to as e.g. a cell, a beam or a beam group. The core network 13, 14 may comprise a packet core network 13 and an IMS core network 14. The packet core network 13 may comprise one or more packet core network nodes 130, such as e.g. a Serving Gateway (Serving GW), a Packet Data Network Gateway (PDN GW), a Mobility Management Entity (MME) and/or a Home Subscriber Server (HSS). The core network 13 may further be connected to an IMS core network 14, comprising a plurality of IMS core network nodes 140 which will be further described in relation to FIG. 2.

In general, UEs 120 that are within coverage of the network node 110, such as e.g., within the cell 115 served by radio network node 110, communicate with the radio network node 110 by transmitting and receiving wireless signals over a radio channel 125, which may also be referred to as a link. For example, the UE 120 and the network node 110 may communicate wireless signals 125 containing voice traffic, data traffic, and/or control signals. When the radio network node 110 is communicating voice traffic, data traffic, and/or control signals to the UE 120 it may be referred to as a serving network node for the UE 120. The wireless signals 125 may include both downlink (DL) transmissions, i.e. from the radio network node 110 to the UE 120, and uplink (UL) transmissions, i.e. from the UE 120 to the network node 110. Each radio network node 110 may have a single transmitter or multiple transmitters for transmitting signals 125 to the UE 120. In some embodiments, the radio network node 110 may comprise a multi-input multi-output (MIMO) system. Similarly, each UE 120 may have a single receiver or multiple receivers for receiving signals 125 from the radio network node 110 or other UEs. Vice versa, the radio network node 110 may have a single receiver or multiple receivers for receiving signals 125 transmitted from the UE 120 or other network nodes, and the UE 120 may have a single transmitter or multiple transmitters for transmitting signals 125 to the radio network node 110. When the UE 120 connects to the communications network it may send a network attach request to the radio network node 110.

FIG. 2 shows an overview of the IMS core network 14 in which the embodiments herein may be implemented. The IMS core network 14 comprises a plurality of IMS core network nodes 140, predominantly a Call Session Control Function (CSCF) node 141a-c and a HSS node 145. The CSCF node 141a-c plays an important role in the IMS core network 140. The CSCF node 141a-c facilitates Session Initiation Protocol (SIP) session setup and teardown. The HSS node 145 plays the role of a location server in the IMS 140, in addition to acting as an Authentication, Authorization and Accounting (AAA) server. The HSS node 145 also serves as a single point of provisioning for IMS subscribers and their services.

The CSCF node 141a-c comprises three logical verticals:

a) Proxy CSCF (P-CSCF) node 141a
b) Interrogating CSCF (I-CSCF) node 141b, and
c) Serving CSCF (S-CSCF) node 141c.

The P-CSCF node 141a acts as an entry point into the IMS core network 14. All UEs 120 located in the IMS core network 14 are attached to the P-CSCF node 141a. The P-CSCF node 141a may be in a home domain or in a visited domain of the UE 120. The P-CSCF node 141a is responsible for routing incoming SIP messages to an IMS registrar server and for facilitating policy control over an Rx interface towards a Policy and Charging Rules Function (PCRF) node 131. The P-CSCF node 141a is also responsible for setting up IPSec Security associations with the UE 120, thus ensuring secure access to the IMS core network 140.

The I-CSCF node 141b acts as an inbound SIP proxy server in the IMS core network 14. During IMS registrations, the I-CSCF node 141b queries the HSS 145 to select an appropriate S-CSCF node 141c which is able to serve a target UE 120. During IMS sessions, the I-CSCF node 141b acts as the entry point to terminating session requests, such as e.g. terminating call procedures. The I-CSCF node 141b routes the incoming session requests to the S-CSCF node 141c of the target UE 120.

The S-CSCF node 141c may act as a registrar server, and in some cases as a redirect server. The S-CSCF node 141c is a central point for IMS service control over an ISC reference point. Moreover, the S-CSCF node 141c facilitates the routing path for mobile originated or mobile terminated session requests. The S-CSCF node 141c may also interact with a Media Resource Function over an MR interface for playing tones and announcements. The functions of the P-CSCF node 141a, the I-CSCF node 141b and the S-CSCF node 141c may be performed in one node, such as e.g. a collocated I/S-CSCF node 141bc, or in a plurality of nodes.

At voice call set-up or at a later stage, such as e.g. during the voice call, the core network node, such as e.g. the IMS core network node 140 and/or the packet core network node 130 may determine a packet delay related to a first voice call. The packet delay related to the first voice call is caused by the core network, such as e.g. the IMS core network 14 and/or the packet core network 13. The IMS core network node 140 and/or the packet core network node 130 are herein also referred to as the core network node 130, 140. The core network node 130, 140 provides a packet delay budget (PDB) available for the RAN to the radio network node 130, wherein the PDB available for the RAN is determined taking packet delays caused by the core network 13, 14 into account. The PDB may be provided to the radio network node as the actual value of the PDB or may be provided as an indication indicating a position in a look up table. When the PDB is determined during call setup, the PDB may be comprised as a parameter in a call setup request message, such as e.g. an Rx request message as defined in 3GPP Technical Specification (TS) 29.214 rev 15.0.0, used for setting up packet core resources for the call between the UE 120 and the core network node 130, 140 and may be sent and/or forwarded to the radio network node 110. The radio network node 110 may, based on the received PDB taking the packet delays caused by the core network 13, 14 into account, schedule the first voice call and/or one or more second voice calls, such that the E2E delay of the first and the one or more second voice calls is below a predetermined threshold, which may herein also be referred to as an E2E threshold. The predetermined threshold is selected such that the packet delay does not negatively affect the user experience of the voice call. The predetermined E2E threshold may be e.g. be set to 225 ms, since this packet delay has been determined to be the inflection point where the quality of the voice call starts to deteriorate.

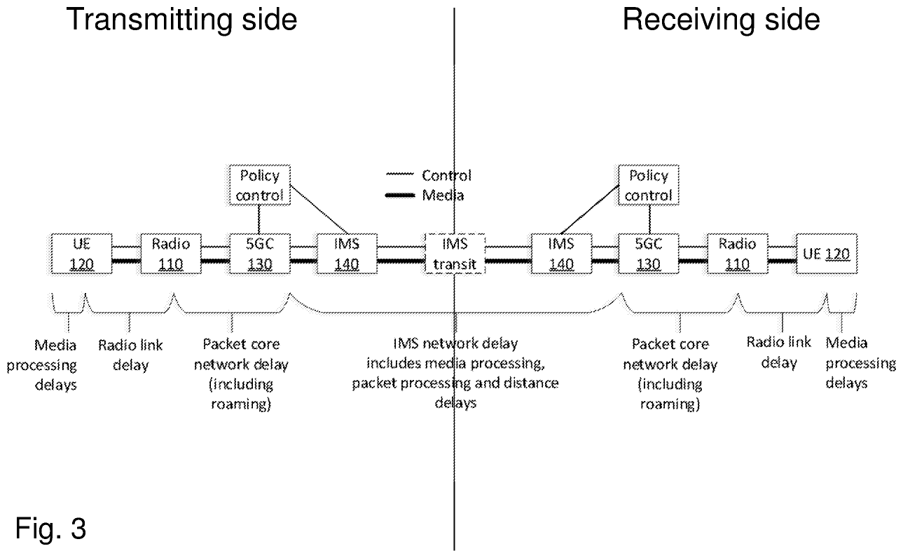

FIG. 3 shows the different delays that the different parts of the network adds to the total delay of an E2E call between two UEs 120, herein exemplified for a 5G network. The total E2E delay comprises an IMS delay caused by the IMS core network nodes 140 on the originating and terminating sides of the communications network 100 and the delay for the transmission between the two IMS core network nodes 140. When calculating the IMS delay for one side of the network only half of the delay should be taken into account. The total E2E delay further comprises a packet core delay caused by the packet core network node 130, herein exemplified as a 5GC node, on the terminating and originating sides, a radio link delay, herein also referred to as a RAN delay, caused by the radio communication between the radio network node 110 and the UE 120 and a media processing delay in each of the originating and terminating UEs 120. The packet core delay may further comprise delays due to roaming.

At voice call set-up or at a later stage, such as e.g. during the call, the IMS core network node 140, such as e.g. the P-CSCF node 141a, may determine an available PDB for the packet core network, such as e.g. a 5^{th} Generation system (5GS) or an Evolved Packet System (EPS), remaining after the packet delay caused by the IMS network 14 has been considered. When the PDB is determined during call setup, an indication of the PDB may be included as one parameter in a call setup request, such as e.g. an Rx or an N7 request, see e.g. 3GPP TS 29.512-514 rev 15.0.0, for resources for the call, sent to a packet core network node 130 for handling policy and control functions, such as e.g. a PCF node 133. When the PCB is determined during the voice call a separate request may be sent as early as possible to the packet core network node 130 for handling policy and control functions. The packet core network node 130 for handling policy and control functions, may at receipt of the PCB from the IMS core network node 140 send an authorization comprising the PDB to a packet core network node 130 for handling session management, such as e.g. a Session Management Function (SMF) node 132 comprised in the packet core network node 130. When establishing a new Quality of Service (QoS) flow to be used for the voice call, such as e.g. a first voice call relating to the first UE 121 and/or one or more second voice calls relating to one or more second UEs 122, the packet core network node 130 for handling session management may, based on knowledge of distances between a selected User Plane Function (UPF) node and a radio network node, determine a PDB that may be provided to the radio network node according to the behaviour specified in 3GPP TS 23.502 v. 15.2.0.

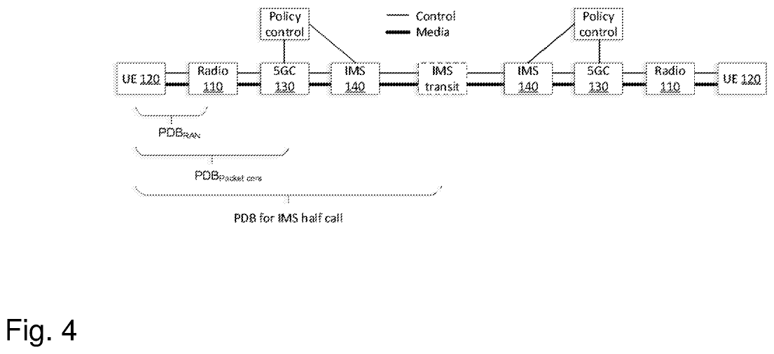

FIG. 4 discloses the calculation of the PDBs for the various parts of the communications network 100 on each of the originating and terminating sides of the communications network 100. The PDB up to IMS half call, i.e. for one of the originating and terminating sides, comprises the PDB for the packet core (PDB_{packet core}), herein exemplified as the PDB for the 5GS, and the PDB for the radio interface (PDB_{RAN}), such as e.g. the radio channel 125, herein exemplified as the PDB for the 5G RAN.

The available PDB that the IMS core network node 140, such as e.g. the P-CSCF 141a, may determine for the packet core network depends on the expected packet delay imposed by the IMS network 14. The term imposed shall herein be interpreted as being caused by the network. By taking the packet delay imposed by the IMS network 14 and/or the packet core network 13 into account when scheduling the UEs 120, the delay in the radio interface may be adjusted so that the E2E delay for each voice call is kept below a predetermined threshold. The predetermined E2E threshold may e.g. be set to 225 ms, since this delay has been determined to be the inflection point where the quality of the voice call starts to deteriorate. The IMS core network node 140, such as the P-CSCF 141a, may estimate the expected packet delay over the IMS network 14 in a plurality of ways, such as e.g.:
1) The SIP URI or Tel URI (which comprises an E164 number comprising a phone number of the user) may provide information about in which geographic area the voice call will be terminated or from which geographic area the voice call originated from, and may determine the expected packet delay based on stored delays associated with a specific geographic area related to the voice call. A country code comprised in the Tel URI may e.g. be associated with a specific PDB.
2) An IMS Access Gateway (AGW) comprised in the IMS core network node 140 may probe the path of the voice call, and may report the packet delay caused by the IMS network 14 to the P-CSCF 141a comprised in the IMS core network node 140. Probing is a well-known principle where the probing node sends a specific probe packet to a receiving node. The receiving node immediately returns the probe packet, and when the sending node receives the returned probe packet the round-trip delay will be known and/or may be estimated by comparing the time stamp of the probe packet with the time it is received.
3) The IMS AGW may calculate the packet delay caused by the IMS network 14 based on information comprised in an RTCP message. The information may e.g. be a Network Time Protocol (NTP) time-stamp comprised in the Real-Time Control Protocol message. For example, the IMS AGW may sniff on the RTCP packet, and can thereby determine packet delays on both sides of the AGW. By sniffing, the IMS AGW intercepts data flowing in a network and may capture each packet and, if needed, decode the packet's raw data, showing the values of various fields in the packet, and may analyze its content. One side of the AGW may be connected to the packet core network 13 and the other may be connected to the IMS network 14. The delay on the IMS network side comprises the packet delay caused by the IMS network 14 and the packet delays caused by the packet core network and radio access network on the other side of the network. By assuming a fixed packet delay in the other network end's packet core network the IMS AGW may roughly estimate the packet delay imposed by the IMS network 14. This may be done repeatedly by both ends' IMS GateWay (GW), thereby the estimated PDB may converge to a reasonably correct value. The ends herein refer to the transmitting end, which may also be referred to as the transmitting side, and the receiving end, which may also be referred to as the receiving side, of the communications network during the voice call.

The estimation of the packet delay caused by the IMS network 14 may further be improved by the IMS core network nodes 140, such as e.g. the P-CSCFs 141a, on each side of the communications network 100 exchanging the packet delay caused by their respective radio access network 10 and packet core network 13, e.g. via an information element in SIP signaling. Then the IMS core network node 140, such as the P-CSCF 141a, may take the packet delay of the IMS network side of the IMS AGW, i.e. the packet delay on a path from the IMS AGW via the IMS network, the packet core network and the radio network on the other side of the communications network 100 to the UE 120, and subtract the actual packet delay caused by the packet core network 13 and the radio access network, such as e.g. the 5GS or EPS on the other side of the network. For clarification, the IMS core network node 140 on the transmitting side may receive the packet delay caused by the radio access network 10 and packet core network 13 from the IMS core network node on the receiving side of the network, e.g. via an information element in SIP signaling. Thereafter the IMS core network node 140 on the transmitting side of the communications network 100 may take the packet delay of the IMS network side of its IMS AGW, i.e. the packet delay on the path from the IMS AGW on the transmitting side of the communications network 100 via the IMS network, the packet core network 13 on the receiving side and the radio access network on the receiving side of the communications network 100 to the receiving UE 120, and subtract the actual packet delay caused by the packet core network 13 and the radio access network on the receiving side of the communications network 100 from the packet delay on the IMS network side of the IMS AGW. Correspondingly, if the IMS core network node 140 is on the receiving side of the communications network 100, it may receive the packet delay caused by the radio access network 10 and packet core network 13 from the IMS core network node on the transmitting side of the communications network 100 and may estimate the packet delay caused by the IMS network 14 by subtracting the received packet delay caused by the radio access network 10 and packet core network 13 from the packet delay on the IMS network side of the IMS AGW.

Each of the IMS core network nodes 140, such as P-CSCFs 141a, involved in the E2E call, such as the IMS core network node 140 on the originating side and the IMS core network node 140 on the terminating side of the communications network, may determine the PDB_{packet core} allowed for their respective packet core networks to be:

PDB_{packet core}=(delay_threshold_{E2E}−(IMS_delay))/2

wherein

delay_threshold_{E2E} is the predetermined threshold for the E2E delay,

IMS_delay is the delay caused by the IMS network.

According to a second example herein, the core network node may also be a packet core network node 130. The packet core network node 130 for handling session management, such as the SMF node 132, may determine the packet delay caused by the packet core network 13 in the communications network 100, which may herein be referred to as 5GC-delay, when calculating the PDB available for the RAN (PDB_{RAN}), such as e.g. a 5G-RAN. For example:
4) Configuration per roaming partner of expected delay. This could be used in case of home routing when roaming. Then the SMF 132 having the interface to PCF 133 will be in a Home Public Land Mobile Network (HPLMN), and there may be a substantial delay because of the connection between HPLMN and a Visited Public Land Mobile Network (VPLMN).
5) The packet core network node 130 may determine the packet delay caused by the packet core network 13 based on the address of the RAN node 110. The packet core network node 130 may identify the geographical area of the RAN node 110 and determine the packet delay associated with the identified geographical area. This may e.g. be done based on stored packet delays associated with the identified geographical area.
6) Probing, by for example using the well-known PING in IP. The PING measures a round-trip time for messages sent from an originating node to a destination node which messages are echoed back to the originating node. The SMF node 132 may request the UPF node to send an IP PING to the radio network node 110 and may then measure the round-trip time for this message in order to determine the packet delay.

The core network node 130 for handling session management, such as the SMF node 132 may determine the PDB available for the radio access network (PDB_{RAN}), such as e.g. the 5G-RAN to be:

PDB_{RAN}=PDB_{packet core}−(5GC_delay)

wherein

PDB_{packet core} is the PDB for the packet core network, which may be determined by the IMS core network node 140

5GC_delay is the packet delay caused by the packet core network.

Alternatively, the packet core network node 130 for handling policy control, such as e.g. the PCF node 133, may determine the PDB for the RAN in a corresponding manner to the second example descried above for the SMF node 132.

Alternatively, the radio network node 110 may calculate the PDB_{RAN} based on the indicated packet delays caused by the core network 13, 14 as follows:

PDB_{RAN}=(delay_threshold_{E2E}−(IMS_delay))/2−5GC_delay

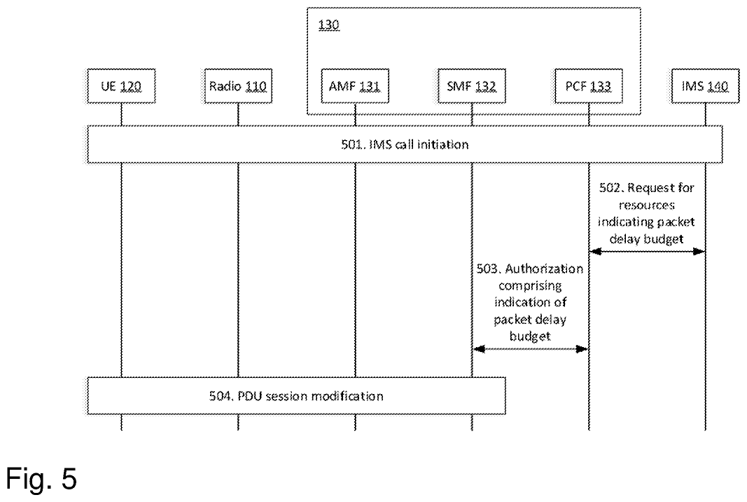

FIG. 5 illustrates a signaling diagram for an E2E call according to embodiments herein. FIG. 5 only illustrates one of the originating or terminating sides of the communications network, however the signaling is identical for both the originating and terminating side of the communications network 100.

Action 501: A voice call is initiated, in accordance with 3GPP TS 23.228 and 24.229.

Action 502: When the IMS core network node 140 has enough information about the voice call, the IMS core network node 140 may request resources from the packet core network node 130 and the radio network node 110. The IMS core network node 140 may provide a PDB for the packet core network 13 taking the packet delay caused by the IMS network 14 into account, such as e.g. the PDB_{packet core}, in the request for resources. For details about this request see 3GPP TS 23.203, 23.503 and 29.214.

Action 503: The packet core network node 130 for handling policy control, in this example the PCF 133, may authorize the resources for the voice call and request the packet core network node 130 for handling resources, in this case the SMF 132 to establish a QoS flow for voice by sending a request to the UE 120, wherein the request comprises the PDB_{packet core} and/or the PDB_{RAN}.

Action 504: The packet core network node 130 performs a PDU session modification according to procedures in 3GPP TS 23.502. This establishes a QoS flow with a certain characteristic, wherein one of the parameters for the characteristics are PDB, and others may be bandwidth etc.

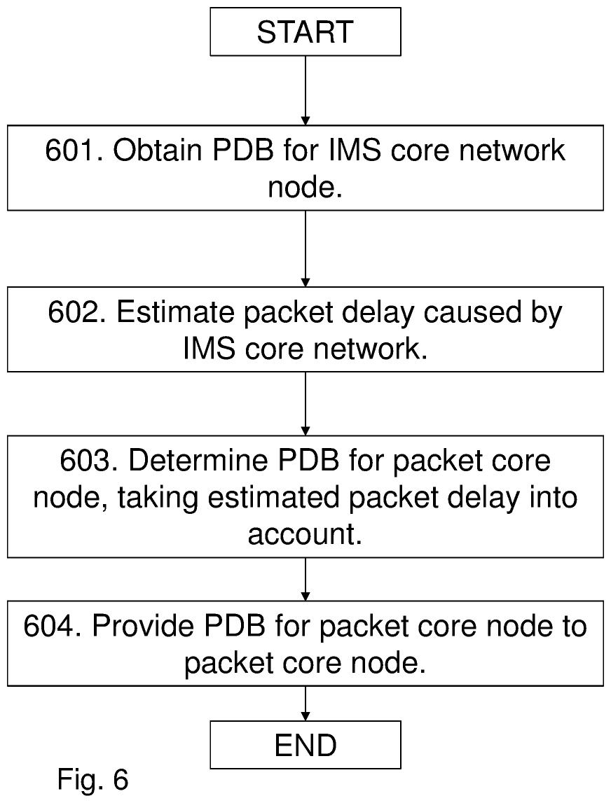

FIG. 6 illustrates the method actions performed by the IMS core network node 140, for handling E2E delays for voice calls in a communications network 100. The communications network 100 comprises the packet core network node 130, the IMS core network node 140 and the radio network node 110. The radio network node 110 serves one or more UEs 120.

Action 601: The IMS network node 140 obtains a PDB for the IMS core network node 140. The PDB for the IMS core network node 140 shall herein be interpreted as the PDB for transmitting a packet to/from the IMS core network node 140 from/to the UE 120.

The PDB for the IMS core network node 140 may e.g. be the E2E threshold minus a packet delay caused by the IMS network and divided by two.

The PDB for the IMS core network node may e.g. be obtained by the IMS core network node 140 being configured with the PDB for the IMS core network node 140, or by receiving an indication of the PDB and/or by the IMS core network node 140 determining a PDB for the IMS core network node based on a desired QoS for the voice call.

Action 602: The IMS network node 140 estimates a packet delay related to a first voice call, wherein the packet delay is caused by the IMS core network 14.

The IMS network node 140 may further estimate a packet delay related to a second voice call, wherein the packet delay for the second voice call is caused by the IMS core network 14.

The estimated packet delay may be a packet delay between an originating IMS access gateway (IMS AGW) and a terminating IMS AGW in the IMS core network 14.

The packet delay may be estimated based on a time-stamp extracted from a Real-Time Transport Protocol, RTP, message and/or a Real-Time Control Protocol, RTCP, message associated with the first voice call and/or the second voice call.

The packet delay may further be estimated based on an indication of a specific geographic area related to the first voice call and/or the second voice calls.

The indication of the geographical area related to the first voice call and/or the second voice calls may e.g. be a SIP Uniform Resource Identifier (URI) or a tel URI.

The packet delay may further be estimated by probing the path of the voice call.

The packet delay may further be estimated according to the examples 1)-3) as described above in relation to FIG. 4.

Action 603: The IMS network node 140 determines a PDB for the packet core network node 130, which is herein also referred to as the PDB_{packet core}, related to the first voice call, taking the obtained packet delay caused by the IMS core network 14 into account.

The IMS network node 140 may further determine a PDB for the packet core network node 130 related to the second voice call, taking the obtained packet delay caused by the IMS core network 14 into account.

By taking the actual delays caused by the IMS core network 14 into account when determining the PDB for the packet core network 13, the IMS core network node 140 enables the packet core network node 130 to provide a more accurate PDB to the radio network node 110. Thereby enabling the radio network node 110 to schedule the voice calls in a more flexible manner, which may improve the QoS of the scheduled voice calls.

Action 604: The IMS network node 140 provides, to the packet core network node 130, the determined PDB related to the first voice call.

The IMS network node 140 may further provide, to the packet core network node 130, the determined PDB related to the second voice call.

The IMS network node 140 may provide the determined packet delay budget to the packet core network node 130 at set-up of the first voice call and/or the second voice calls.

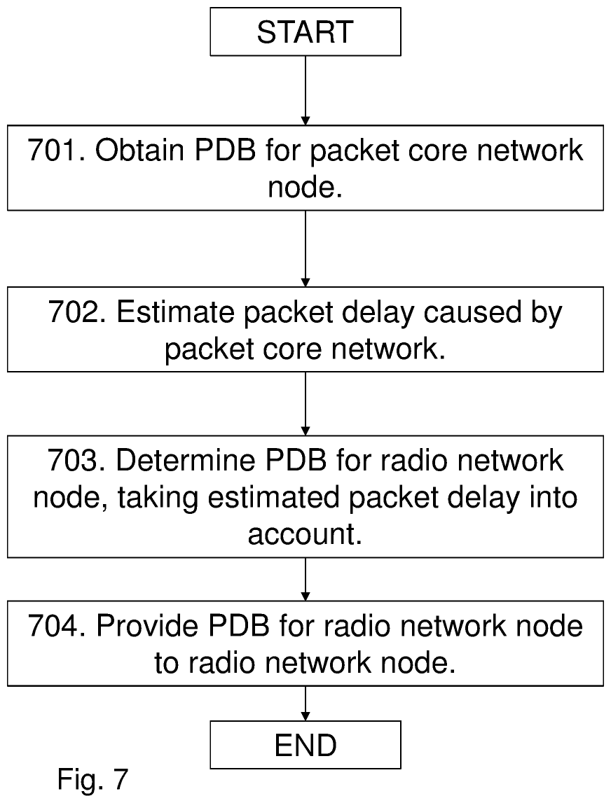

FIG. 7 illustrates the method actions performed by the packet core network node 130, for handling E2E delays for voice calls in a communications network 100. The communications network 100 comprises the packet core network node 130, the IMS core network node 140 and the radio network node 110. The radio network node 110 serves one or more UEs 120.

Action 701: The packet core network node 130 obtains a PDB for the packet core network node 130 from the IMS core network node 140. The packet delay relates to a first voice call. The first call may be associated with a first UE 121 out of the one or more UEs 120. The PDB for the packet core network node 130, may herein also be referred to as the PDB_{packet core}. The PDB for the packet core network node 130, shall herein be interpreted as the PDB for transmitting a packet to/from the packet core network node 130 from/to the UE 120.

Action 702: The packet core network node 130 estimates a packet delay related to a first voice call, wherein the packet delay is caused by the packet core network 13.

The packet core network node 130 may further estimate a packet delay related to a second voice call, wherein the packet delay related to the second voice call is caused by the packet core network.

Action 703: The packet core network node 130 determines a packet delay budget for a radio network node 110, which herein is also referred to as PDB_{RAN}, wherein the PDB is related to the first voice call, taking the obtained packet delay caused by the packet core network 13 into account.

The packet core network node 130 may further determine a packet delay budget for the radio network node 110 related to the second voice call, taking the obtained packet delay caused by the packet core network 13 into account. The packet delay budget for the radio network node 110 may herein also be referred to as PDB_{RAN}.

The estimated packet delay may be a packet delay between a serving packet core gateway and a remote packet core gateway in the packet core network 13.

The packet core network node 130 may estimate the packet delay based on an indication of a specific geographic area related to the first voice call and/or the second voice call.

The indication of the geographical area related to the first voice call and/or the second voice call may be an IP address of a serving and/or a remote packet core gateway.

By taking the actual delays caused by the packet core network 13 into account when determining the PDB for the radio network node 110, the packet core network node 130 enables the radio network node 110 to schedule the voice calls based on a more accurate PDB for each voice call in the RAN. This allows a more flexible scheduling of the voice calls, and allows the radio network node to improve the QoS of the scheduled voice calls by scheduling each voice call within its determined PDB.

Action 704: The packet core network node 130 may further provide the determined PDB for the radio network node 110 related to the first voice call to the radio network node 110.

The packet core network node 130 may further provide the determined PDB related to the second voice call to the packet core network node 130.

The packet core network node 130 may provide the determined packet delay budget to the radio network node 110 at set-up of the first voice call and/or the second voice call.

The packet core network node 130 may e.g. be a PCF node and/or a PCRF node comprised in the packet core network 13.

The PDB provided to the radio network node 110 may indicate a maximum packet delay allowed within RAN.

The packet core network node 130 may determine the PDB for the radio network node 110 according to the calculations described above for the PDB_{RAN}.

When the core network node is an IMS core network node 140, this may comprise determining the PDB for the packet core network 13 and the radio access network, herein exemplified as the PDB_{packet core}. When the core network node is a packet core network node 130, this may comprise determining the PDB for the radio access network, herein exemplified as the PDB_{RAN}. The core network node 130, 140 may further send an indication of the determined PDB to the radio network node 110

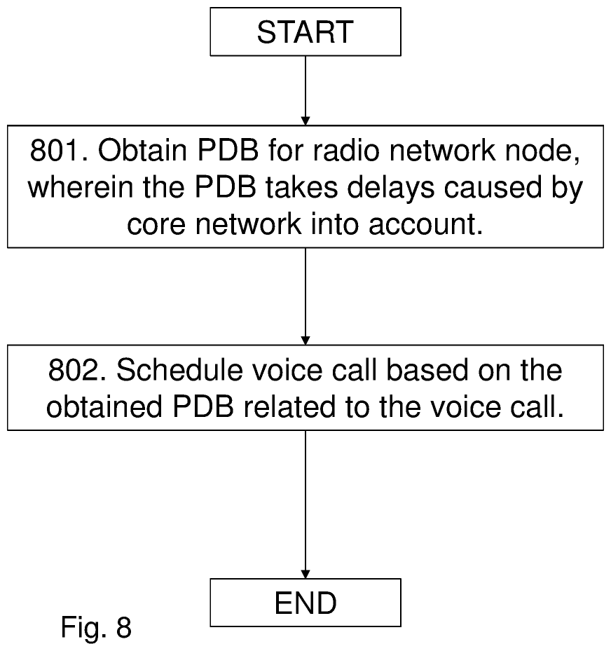

FIG. 8 illustrates the method actions performed by the radio network node 110, for handling E2E delays for voice calls in a communications network 100. The communications network 100 comprises the packet core network node 130, the IMS core network node 140 and the radio network node 110.The radio network node 110 serves one or more UEs 120, such as the first UE 121 and the second UE 122.

Action 801: The radio network node 110 obtains a Packet Delay Budget, PBD, for the radio network node 110. The PDB is related to a first voice call associated with a first UE 121 of the one or more UEs 120 and the packet delay budget takes packet delays caused by a core network 13, 14 into account. The core network may e.g. be the IMS core network 13 and/or the packet core network 14.

The radio network node 110 may further obtain a packet delay budget for the radio network node 110, wherein the PDB is related to one or more second voice calls related to a second UE 122 of the one or more UEs 120, wherein the packet delay budget takes packet delays caused by a core network 13, 14 into account.

The radio network node 110 may obtain the PDB at set-up of the first voice call. The radio network node 110 may obtain the PDB during the first voice call.

The obtained packet delay budget may be the calculated PDB that the RAN is allowed in order to compensate for delays caused by the core network 13, 14. See calculation above for the PDB_{5G-RAN}.

Action 802: The radio network node 110 schedules the first voice call based on the obtained indication of the packet delay budget associated with the first voice call.

The radio network node 110 may schedule the first voice call based on the obtained indication of the PDBs associated with the first and the second voice calls.

The radio network node 110 may schedule the first voice call and/or the second voice call such that the E2E delay of the first and the one or more second voice calls is below a predetermined threshold. The threshold may be set such that a predetermined level of QoS for the voice call is achieved. The threshold may e.g. be set so that the E2E delay does not exceed 300 ms, or preferably 225 ms.The threshold may e.g. be set to 300 ms, or preferably 225 ms.

The radio network node 110 may further schedule the first voice call taking into account a plurality of PDBs for a plurality of voice calls, which may herein also be referred to connections, within a cell served by the radio network node 110.

The radio network node 110 may schedule the first voice call and/or the one or more second voice calls such that the E2E delay of the first voice call and the one or more second voice calls is below a predetermined threshold, by scheduling the first and/or second voice calls within the obtained PDBs. The one or more voice calls may be related to the one or more UEs 120 served by the radio network node 110.

The radio network node 110 may e.g. prioritize a long distance voice call having a higher packet delay in the core network 13, 14 and thus a smaller PDB over a short distance voice call having a smaller packet delay in the core network 13, 14 and thus a higher PDB.

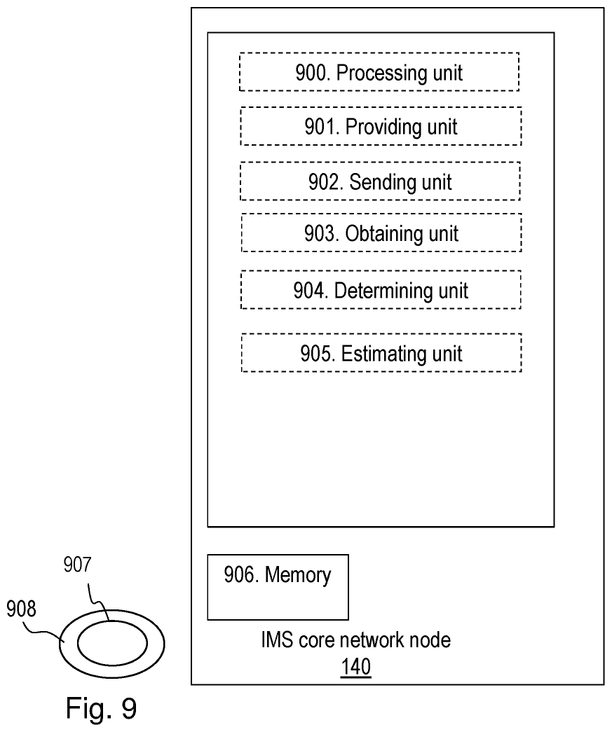

FIG. 9 is a block diagram depicting the IMS core network node 140, for handling end-to-end, E2E, delays for voice calls in the communications network 100. The IMS core network node 140 may comprise a processing unit 900, such as e.g. one or more processors, a providing unit 901 and/or a sending unit 902 and/or an obtaining unit 903 and/or a determining unit 904 and/or an estimating unit 905 as exemplifying hardware units configured to perform the method as described herein. The IMS core network node 140 may e.g. be a CSCF node 141.

The IMS core network node 140 is configured to, e.g. by means of the processing unit 900 and/or the obtaining unit 903 being configured to, obtain a PDB for the IMS core network node 140.

The IMS core network node 140 is configured to, e.g. by means of the processing unit 900 and/or the estimating unit 905 being configured to, estimate a packet delay related to a first voice call, wherein the packet delay is caused by the IMS core network 14,

The IMS core network node 140 is configured to, e.g. by means of the processing unit 900 and/or the determining unit 904 being configured to, determine the PDB for the packet core network node 130 related to the first voice call, taking the estimated packet delay caused by the IMS core network 14 into account.

The IMS core network node 140 is configured to, e.g. by means of the processing unit 900 and/or the providing unit 901 being configured to, provide the determined packet delay budget related to the first voice call to the packet core network node 130.

The IMS core network node 140 may further be configured to, e.g. by means of the processing unit 900 and/or the estimating unit 905 being configured to, estimate a packet delay related to the second voice call, wherein the packet delay related to the second voice call is caused by the IMS core network 14,

The IMS core network node 140 may further be configured to, e.g. by means of the processing unit 900 and/or the determining unit 904 being configured to, determine a packet delay budget for the packet core network node 130 related to the second voice call, taking the estimated packet delay caused by the IMS core network 14 into account,

The IMS core network node 140 may further be configured to, e.g. by means of the processing unit 900 and/or the providing unit 901 being configured to, provide the determined packet delay budget related to the second voice call to the packet core network node 130.

The IMS core network node 140 is configured to, e.g. by means of the processing unit 900 and/or the estimating unit 905 being configured to, estimate the packet delay as a packet delay between a serving access gateway, AGW, and a remote AGW in the IMS core network 14.

The IMS core network node 140 is configured to, e.g. by means of the processing unit 900 and/or the estimating unit 905 being configured to, estimate the packet delay based on a time-stamp extracted from a Real-Time Transport Protocol, RTP, message and/or a Real-Time Control Protocol, RTCP, message associated with the first voice call and/or the second voice call.

The IMS core network node 140 is configured to, e.g. by means of the processing unit 900 and/or the estimating unit 905 being configured to, estimate the packet delay based on an indication of a specific geographic area related to the first voice call and/or the second voice calls.

The IMS core network node 140 is configured to, e.g. by means of the processing unit 900 and/or the obtaining unit 903 and/or the receiving unit 905 being configured to, receive a SIP URI or a tel URI as an indication of the geographical area related to the first voice call and/or the second voice call.

The IMS core network node 140 may further be configured to, e.g. by means of the processing unit 900 and/or the obtaining unit 903 and/or the determining unit 904 being configured to, determine the PDB based on stored PDBs associated with the indicated specific geographic area related to the first voice call.

The IMS core network node 140 may further be configured to, e.g. by means of the processing unit 900 and/or the providing unit 901 being configured to, provide the determined packet delay budget to the packet core network node 130 at set-up of the first voice call and/or the second voice calls.

The IMS core network node 140 may further be configured to, e.g. by means of the processing unit 900 and/or the obtaining unit 903 and/or the determining unit 904 being configured to, determine, based on the estimated packet delay for the IMS core network 14, the PDB available for the remaining parts of the access network after the packet delay for the IMS core network 14 has been subtracted.

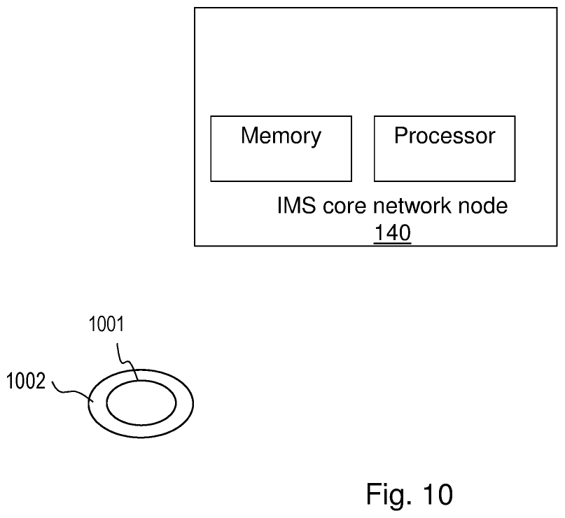

The embodiments herein may be implemented through a respective processor or one or more processors of a processing circuitry in the IMS core network node 140 as depicted in FIG. 10, which processing circuitry is configured to perform the method actions according to FIG. 6 and the embodiments described above for the IMS core network node 140.

The embodiments may be performed by the processor together with respective computer program code for performing the functions and actions of the embodiments herein. The program code mentioned above may also be provided as a computer program product, for instance in the form of a data carrier carrying computer program code for performing the embodiments herein when being loaded into the IMS core network node 140. One such carrier may be in the form of a CD ROM disc. It is however feasible with other data carriers such as e.g. a memory stick. The computer program code may furthermore be provided as pure program code on a server and downloaded to the IMS core network node 140.

The IMS core network node 140 may further comprise a memory 906. The memory may comprise one or more memory units to be used to store data on, such as software, patches, system information, configurations, diagnostic data, performance data and/or applications to perform the methods disclosed herein when being executed, and similar.

The method according to the embodiments described herein for the IMS core network node 140 may be implemented by means of e.g. a computer program product 907, 1001 or a computer program, comprising instructions, i.e., software code portions, which, when executed on at least one processor, cause at least one processor to carry out the actions described herein, as performed by the IMS core network node140. The computer program product 907, 1001 may be stored on a computer-readable storage medium 908, 1002, e.g. a disc or similar. The computer-readable storage medium 908, 1002, having stored thereon the computer program, may comprise instructions which, when executed on at least one processor, cause the at least one processor to carry out the actions described herein, as performed by the IMS core network node 140. In some embodiments, the computer-readable storage medium may be a non-transitory computer-readable storage medium. The computer program may also be comprised on a carrier, wherein the carrier is one of an electronic signal, optical signal, radio signal, or a computer readable storage medium.

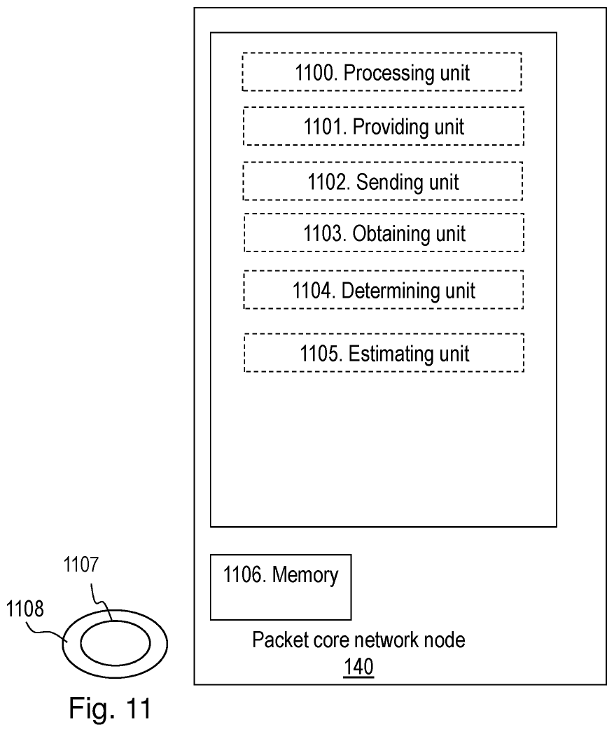

FIG. 11 is a block diagram depicting the packet core network node 130, for handling end-to-end, E2E, delays for voice calls in the communications network 100. The packet core network node 130 may comprise a processing unit 1100, such as e.g. one or more processors, a providing unit 1101 and/or a sending unit 1102 and/or an obtaining unit 1103 and/or a determining unit 1104 and/or an estimating unit 1105 as exemplifying hardware units configured to perform the method as described herein. The radio network node 110 is configured to serve one or more UEs 120

The packet core network node 130 is configured to, e.g. by means of the processing unit 1100 and/or the obtaining unit 1103 being configured to, obtain, from the IMS core network node 140, a PDB for the packet core network node 130, wherein the PDB relates to a first voice call.

The packet core network node 130 is configured to, e.g. by means of the processing unit 1100 and/or the estimating unit 1105 being configured to, estimate a packet delay related to a first voice call, wherein the packet delay is caused by the packet core network 13,

The packet core network node 130 is configured to, e.g. by means of the processing unit 1100 and/or the determining unit 1104 being configured to, determine a PDB for the radio network node 110, wherein the PDB is related to the first voice call, while taking the estimated packet delay caused by the packet core network 13 into account

The packet core network node 130 is configured to, e.g. by means of the processing unit 1100 and/or the providing unit 1101 and/or the sending unit 1102 being configured to, provide the determined PDB for the radio network node 110 related to the first voice call, to the radio network node 110.

The packet core network node 130 may further be configured to, e.g. by means of the processing unit 1100 and/or the estimating unit 1105 being configured to, estimate the packet delay related to a second voice call, wherein the packet delay is caused by the packet core network 13.

The packet core network node 130 may further be configured to, e.g. by means of the processing unit 1100 and/or the determining unit 1104 being configured to, determine a PDB for the radio network node 110 related to the second voice call, taking the obtained packet delay caused by the packet core network 13 into account.

The packet core network node 130 may further be configured to, e.g. by means of the processing unit 1100 and/or the providing unit 1101 and/or the sending unit 1102 being configured to, provide, to the radio network node 110, the determined packet delay budget for the radio network node 110 related to the second voice call.

The packet core network node 130 may further be configured to, e.g. by means of the processing unit 1100 and/or the estimating unit 1105 being configured to, estimate the packet delay as a packet delay between a serving packet core gateway and a remote packet core gateway in the packet core network 13.

The packet core network node 130 may further be configured to, e.g. by means of the processing unit 1100 and/or the estimating unit 1105 being configured to, estimate the packet delay based on an indication of a specific geographic area related to the first voice call and/or the second voice call.

The packet core network node 130 may further be configured to, e.g. by means of the processing unit 1100 and/or the estimating unit 1105 being configured to, estimate the packet delay in the packet core network 13 based on an IP address of a serving and/or a remote packet core gateway as indication of the geographical area related to the first voice call and/or the second voice calls.

The packet core network node 130 may further be configured to, e.g. by means of the processing unit 1100 and/or the providing unit 1101 and/or the sending unit 1102 being configured to, provide the determined PDB to the radio network node 110 at set-up of the first voice call and/or the second voice calls.

The packet core network node 130 may further be configured to, e.g. by means of the processing unit 1100 and/or the obtaining unit 1103 and/or the determining unit 1104 being configured to, determine the PDB for the radio network node 130 based on stored PDBs associated with the indicated specific geographic area related to the first voice call.

The packet core network node 130 may further be configured to, e.g. by means of the processing unit 1100 and/or the obtaining unit 1103 and/or the determining unit 1104 being configured to, determine, based on the estimated packet delay for the packet core network 14, the PDB available for the remaining parts of the access network, such as e.g. the RAN, after the packet delay for the packet core network 13 has been subtracted.

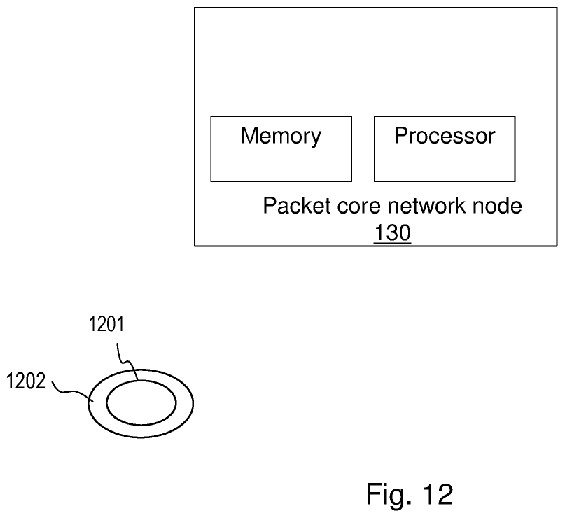

The embodiments herein may be implemented through a respective processor or one or more processors of a processing circuitry in the packet core network node 130 as depicted in FIG. 12, which processing circuitry is configured to perform the method actions according to FIG. 8 and the embodiments described above for the packet core network node 130.

The embodiments may be performed by the processor together with respective computer program code for performing the functions and actions of the embodiments herein. The program code mentioned above may also be provided as a computer program product, for instance in the form of a data carrier carrying computer program code for performing the embodiments herein when being loaded into the packet core network node 130. One such carrier may be in the form of a CD ROM disc. It is however feasible with other data carriers such as e.g. a memory stick. The computer program code may furthermore be provided as pure program code on a server and downloaded to the packet core network node 130.

The packet core network node 130 may further comprise a memory 1106. The memory may comprise one or more memory units to be used to store data on, such as software, patches, system information, configurations, diagnostic data, performance data and/or applications to perform the methods disclosed herein when being executed, and similar.

The method according to the embodiments described herein for the packet core network node 130 may be implemented by means of e.g. a computer program product 1107, 1201 or a computer program, comprising instructions, i.e., software code portions, which, when executed on at least one processor, cause at least one processor to carry out the actions described herein, as performed by the packet core network node 130. The computer program product 1107, 1201 may be stored on a computer-readable storage medium 1108, 1202, e.g. a disc or similar. The computer-readable storage medium 1108, 1202, having stored thereon the computer program, may comprise instructions which, when executed on at least one processor, cause the at least one processor to carry out the actions described herein, as performed by the packet core network node 130. In some embodiments, the computer-readable storage medium may be a non-transitory computer-readable storage medium. The computer program may also be comprised on a carrier, wherein the carrier is one of an electronic signal, optical signal, radio signal, or a computer readable storage medium.

As will be readily understood by those familiar with communications design, that functions means or units may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a network node.

Alternatively, several of the functional elements of the processing means discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware, read-only memory (ROM) for storing software, random-access memory for storing software and/or program or application data, and non-volatile memory. Other hardware, conventional and/or custom, may also be included. Designers of network nodes or devices will appreciate the cost, performance, and maintenance trade-offs inherent in these design choices.

The packet core network node 130 and/or the IMS core network node 140, described in the embodiments herein may also be implemented in a cloud. Although the method actions performed by the packet core network node 130 and/or the IMS core network node 140 herein are discussed in the context of a core network node, the method may also be performed by a distributed node comprised in a first cloud, such as e.g. a server and/or a datacenter. The method actions may e.g. be performed by a logical function, which may be a centralized service hosted on the core network node or the distributed node.

It shall be noted that the nodes mentioned herein may be arranged as separate nodes or may be collocated within one or more nodes in the communications network. When a plurality of nodes are collocated in one node, the single node may be configured to perform the actions of each of the collocated nodes.

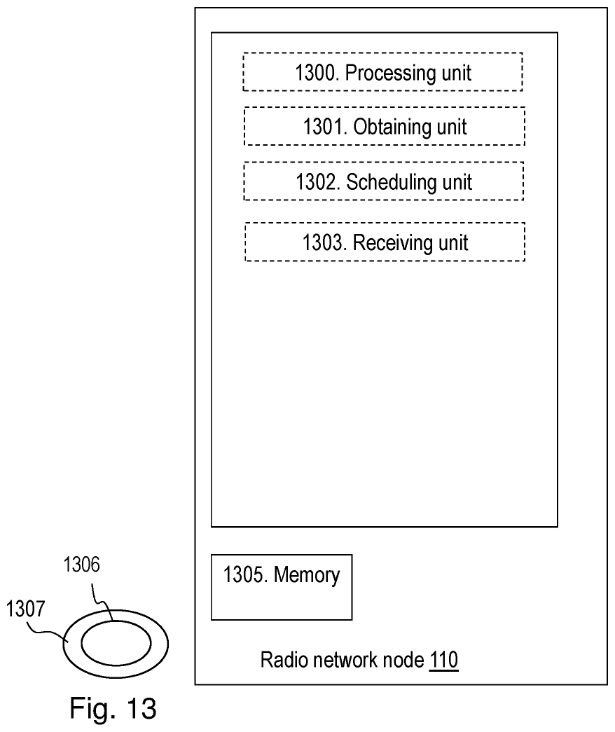

FIG. 13 is a block diagram depicting the radio network node 110, for handling E2E delays for voice calls in the communications network 100. The radio network node 110 is serving one or more UEs 120. The radio network node 110 may comprise a processing unit 1300, such as e.g. one or more processors, an obtaining unit 1301, a scheduling unit 1302 and/or a receiving unit 1303 as exemplifying hardware units configured to perform the method as described herein.

The radio network node 110 is configured to, e.g. by means of the processing unit 1300 and/or the obtaining unit 1301 and/or the receiving unit 1303 being configured to, obtain the PBD for the radio network node 110, related to the first voice call associated with the first UE 121 of the one or more UEs 120, wherein the PDB takes packet delays caused by the core network 13, 14 into account.

The radio network node 110 is configured to, e.g. by means of the processing unit 1300 and/or the scheduling unit 1302 being configured to, schedule the first voice call based on the obtained indication of the packet delay budget associated with the first voice call.

The radio network node 110 may further be configured to, e.g. by means of the processing unit 1300 and/or the obtaining unit 1301 and/or the receiving unit 1303 being configured to, obtain the PDB for the radio network node 110, related to the one or more second voice calls related to a second UE 122 of the one or more UEs 120, wherein the PDB is, wherein the packet delay budget takes packet delays caused by the core network 13, 14 into account.

The radio network node 110 may further be configured to, e.g. by means of the processing unit 1300 and/or the scheduling unit 1302 being configured to, schedule the first voice call based on the obtained indication of the packet delay budgets associated with the first and the second voice calls.

The radio network node 110 may be configured to, e.g. by means of the processing unit 1300 and/or the scheduling unit 1302 being configured to, schedule the first voice call and/or the second voice call such that the E2E delay of the first voice call and/or the second voice call is below a predetermined threshold.

The radio network node 110 is configured to, e.g. by means of the processing unit 1300 and/or the obtaining unit 1301 and/or the receiving unit 1303 being configured to, obtain the PDB at set-up of the first voice call.

The radio network node 110 is configured to, e.g. by means of the processing unit 1300 and/or the obtaining unit 1301 and/or the receiving unit 1303 being configured to, obtain the PDB during the first voice call.

The radio network node 110 may further be configured to, e.g. by means of the processing unit 1300 and/or the obtaining unit 1301 and/or the receiving unit 1303 being configured to, obtain the PDB from the packet core network node 130 and/or the IMS core network node 140.

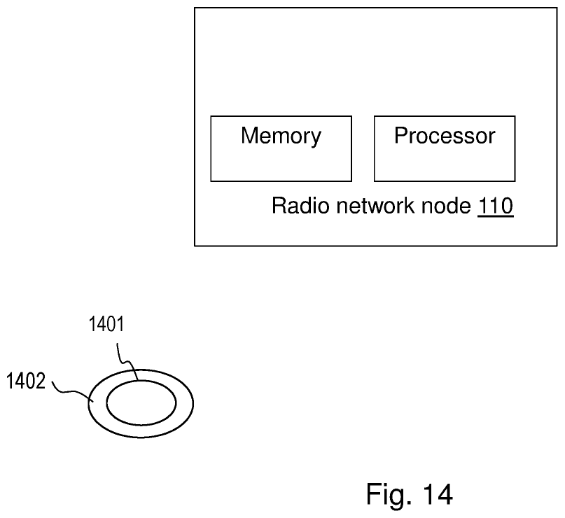

The embodiments herein may be implemented through a respective processor or one or more processors of a processing circuitry in the radio network node 110 as depicted in FIG. 14, which processing circuitry is configured to perform the method actions according to FIG. 8 and the embodiments described above for the radio network node 110.

The embodiments may be performed by the processor together with respective computer program code for performing the functions and actions of the embodiments herein. The program code mentioned above may also be provided as a computer program product, for instance in the form of a data carrier carrying computer program code for performing the embodiments herein when being loaded into the radio network node 110. One such carrier may be in the form of a CD ROM disc. It is however feasible with other data carriers such as e.g. a memory stick. The computer program code may furthermore be provided as pure program code on a server and downloaded to the radio network node 110.

The radio network node 110 may further comprise a memory 1305. The memory may comprise one or more memory units to be used to store data on, such as software, patches, system information, configurations, diagnostic data, performance data and/or applications to perform the methods disclosed herein when being executed, and similar.

The method according to the embodiments described herein for the radio network node 110 may be implemented by means of e.g. a computer program product 1306, 1401 or a computer program, comprising instructions, i.e., software code portions, which, when executed on at least one processor, cause at least one processor to carry out the actions described herein, as performed by the radio network node 110. The computer program product 1306, 1401 may be stored on a computer-readable storage medium 1307, 1402, e.g. a disc or similar. The computer-readable storage medium 1307, 1402, having stored thereon the computer program, may comprise instructions which, when executed on at least one processor, cause the at least one processor to carry out the actions described herein, as performed by the radio network node 110. In some embodiments, the computer-readable storage medium may be a non-transitory computer-readable storage medium. The computer program may also be comprised on a carrier, wherein the carrier is one of an electronic signal, optical signal, radio signal, or a computer readable storage medium.

As will be readily understood by those familiar with communications design, that functions means or units may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a network node.

Alternatively, several of the functional elements of the processing means discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware, read-only memory (ROM) for storing software, random-access memory for storing software and/or program or application data, and non-volatile memory. Other hardware, conventional and/or custom, may also be included. Designers of network nodes or devices will appreciate the cost, performance, and maintenance trade-offs inherent in these design choices.

The radio network node 110, described in the embodiments herein may also be implemented in a cloud. Although the method actions performed by the radio network node 110 herein are discussed in the context of a radio network node, the method may also be performed by a core network node or a distributed node comprised in a first cloud, such as e.g. a server and/or a datacenter. The method actions may e.g. be performed by a logical function, which may be a centralized service hosted on the core network node or the distributed node.

It shall be noted that the nodes mentioned herein may be arranged as separate nodes or may be collocated within one or more nodes in the communications network. When a plurality of nodes are collocated in one node, the single node may be configured to perform the actions of each of the collocated nodes.

### Further Extensions and Variations

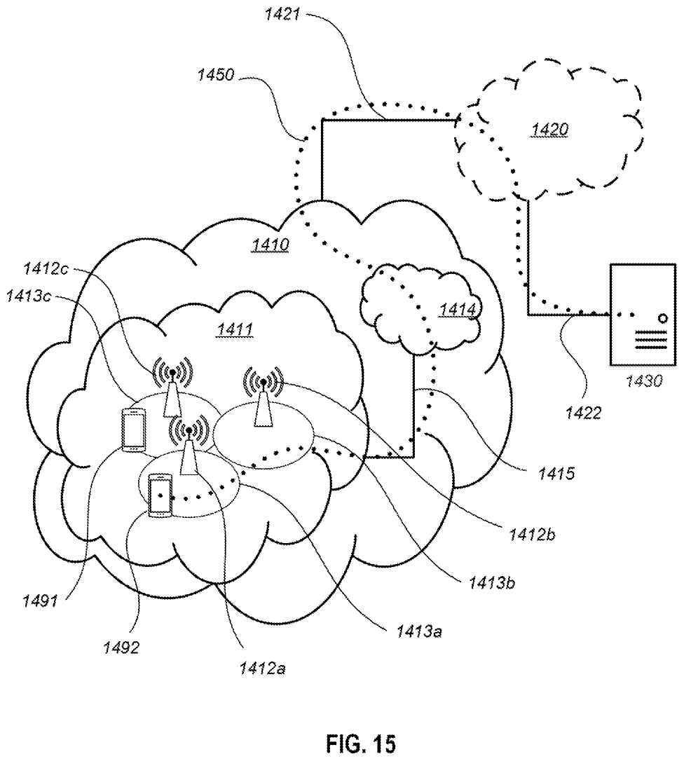

With reference to FIG. 15, in accordance with an embodiment, a communication system includes a telecommunication network 1410 such as the wireless communications network 100, e.g. a WLAN, such as a 3GPP-type cellular network, which comprises an access network 1411, such as a radio access network, and a core network 1414. The access network 1411 comprises a plurality of base stations 1412a, 1412b, 1412c, such as e.g. the radio network node 110, access nodes, AP STAs NBs, eNBs, gNBs or other types of wireless access points, each defining a corresponding coverage area 1413a, 1413b, 1413c. Each base station 1412a, 1412b, 1412c is connectable to the core network 1414, such as e.g. the core network 13, 14, over a wired or wireless connection 1415. A first UE, such as e.g. the UE 121, such as a Non-AP STA 1491 located in coverage area 1413c is configured to wirelessly connect to, or be paged by, the corresponding base station 1412c. A second UE 1492, such as e.g. the UE 122, such as a Non-AP STA in coverage area 1413a is wirelessly connectable to the corresponding base station 1412a. While a plurality of UEs 1491, 1492, such as the UEs 120, 121, 122 are illustrated in this example, the disclosed embodiments are equally applicable to a situation where a sole UE is in the coverage area or where a sole UE is connecting to the corresponding base station 1412.

The telecommunication network 1410 is itself connected to a host computer 1430, which may be embodied in the hardware and/or software of a standalone server, a cloud-implemented server, a distributed server or as processing resources in a server farm. The host computer 1430 may be under the ownership or control of a service provider, or may be operated by the service provider or on behalf of the service provider. The connections 1421, 1422 between the telecommunication network 1410 and the host computer 1430 may extend directly from the core network 1414 to the host computer 1430 or may go via an optional intermediate network 1420. The intermediate network 1420 may be one of, or a combination of more than one of, a public, private or hosted network; the intermediate network 1420, if any, may be a backbone network or the Internet; in particular, the intermediate network 1420 may comprise two or more sub-networks (not shown).

The communication system of FIG. 15 as a whole enables connectivity between one of the connected UEs 1491, 1492 and the host computer 1430. The connectivity may be described as an over-the-top (OTT) connection 1450. The host computer 1430 and the connected UEs 1491, 1492 are configured to communicate data and/or signaling via the OTT connection 1450, using the access network 1411, such as the radio access network 11, the core network 1414, such as e.g. the packet core network 13 and/or the IMS core network 14, any intermediate network 1420 and possible further infrastructure (not shown) as intermediaries. The OTT connection 1450 may be transparent in the sense that the participating communication devices through which the OTT connection 1450 passes are unaware of routing of uplink and downlink communications. For example, a base station 1412 may not or need not be informed about the past routing of an incoming downlink communication with data originating from a host computer 1430 to be forwarded (e.g., handed over) to a connected UE 1491. Similarly, the base station 1412 need not be aware of the future routing of an outgoing uplink communication originating from the UE 1491 towards the host computer 1430.

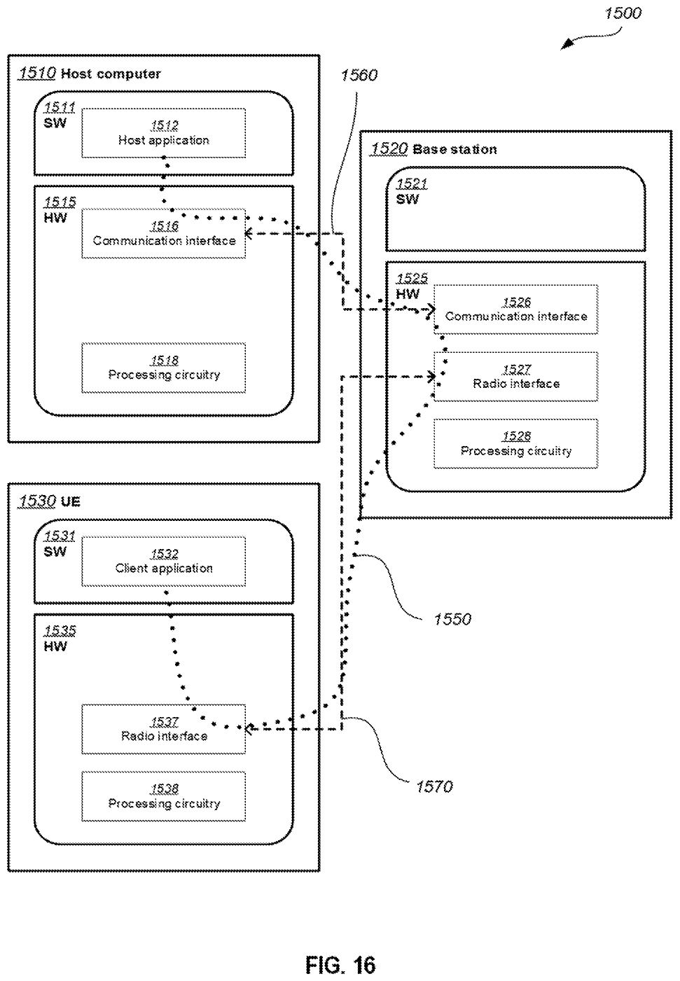

Example implementations, in accordance with an embodiment, of the UE, base station and host computer discussed in the preceding paragraphs will now be described with reference to FIG. 16. In a communication system 1500, a host computer 1510 comprises hardware 1515 including a communication interface 1516 configured to set up and maintain a wired or wireless connection with an interface of a different communication device of the communication system 1500. The host computer 1510 further comprises processing circuitry 1518, which may have storage and/or processing capabilities. In particular, the processing circuitry 1518 may comprise one or more programmable processors, application-specific integrated circuits, field programmable gate arrays or combinations of these (not shown) adapted to execute instructions. The host computer 1510 further comprises software 1511, which is stored in or accessible by the host computer 1510 and executable by the processing circuitry 1518. The software 1511 includes a host application 1512. The host application 1512 may be operable to provide a service to a remote user, such as a UE 1530 connecting via an OTT connection 1550 terminating at the UE 1530 and the host computer 1510. In providing the service to the remote user, the host application 1512 may provide user data which is transmitted using the OTT connection 1550.

The communication system 1500 further includes a base station 1520 provided in a telecommunication system and comprising hardware 1525 enabling it to communicate with the host computer 1510 and with the UE 1530. The hardware 1525 may include a communication interface 1526 for setting up and maintaining a wired or wireless connection with an interface of a different communication device of the communication system 1500, as well as a radio interface 1527 for setting up and maintaining at least a wireless connection 1570 with a UE 1530 located in a coverage area (not shown in FIG. 16) served by the base station 1520. The communication interface 1526 may be configured to facilitate a connection 1560 to the host computer 1510. The connection 1560 may be direct or it may pass through a core network, such as the packet core network 13 and/or the IMS core network 14, (not shown in FIG. 16) of the telecommunication system and/or through one or more intermediate networks outside the telecommunication system. In the embodiment shown, the hardware 1525 of the base station 1520 further includes processing circuitry 1528, which may comprise one or more programmable processors, application-specific integrated circuits, field programmable gate arrays or combinations of these (not shown) adapted to execute instructions. The base station 1520 further has software 1521 stored internally or accessible via an external connection.

The communication system 1500 further includes the UE 1530 already referred to. Its hardware 1535 may include a radio interface 1537 configured to set up and maintain a wireless connection 1570 with a base station serving a coverage area in which the UE 1530 is currently located. The hardware 1535 of the UE 1530 further includes processing circuitry 1538, which may comprise one or more programmable processors, application-specific integrated circuits, field programmable gate arrays or combinations of these (not shown) adapted to execute instructions. The UE 1530 further comprises software 1531, which is stored in or accessible by the UE 1530 and executable by the processing circuitry 1538. The software 1531 includes a client application 1532. The client application 1532 may be operable to provide a service to a human or non-human user via the UE 1530, with the support of the host computer 1510. In the host computer 1510, an executing host application 1512 may communicate with the executing client application 1532 via the OTT connection 1550 terminating at the UE 1530 and the host computer 1510. In providing the service to the user, the client application 1532 may receive request data from the host application 1512 and provide user data in response to the request data. The OTT connection 1550 may transfer both the request data and the user data. The client application 1532 may interact with the user to generate the user data that it provides.

It is noted that the host computer 1510, base station 1520 and UE 1530 illustrated in FIG. 16 may be identical to the host computer 1430, one of the base stations 1412a, 1412b, 1412c and one of the UEs 1491, 1492 of FIG. 14, respectively. This is to say, the inner workings of these entities may be as shown in FIG. 16 and independently, the surrounding network topology may be that of FIG. 14.

In FIG. 16, the OTT connection 1550 has been drawn abstractly to illustrate the communication between the host computer 1510 and the use equipment 1530 via the base station 1520, without explicit reference to any intermediary devices and the precise routing of messages via these devices. Network infrastructure may determine the routing, which it may be configured to hide from the UE 1530 or from the service provider operating the host computer 1510, or both. While the OTT connection 1550 is active, the network infrastructure may further take decisions by which it dynamically changes the routing (e.g., on the basis of load balancing consideration or reconfiguration of the network).

The wireless connection 1570 between the UE 1530 and the base station 1520 is in accordance with the teachings of the embodiments described throughout this disclosure. One or more of the various embodiments improve the performance of OTT services provided to the UE 1530 using the OTT connection 1550, in which the wireless connection 1570 forms the last segment. More precisely, the teachings of these embodiments may improve the latency of the RAN since voice calls with a large packet delay in the core network may be prioritized over voice calls with a small packet delay and thereby provide benefits such as reduced user waiting time and improved quality of service for voice calls, by allowing the RAN to provide the best possible QoS for all users in a cell.

A measurement procedure may be provided for the purpose of monitoring data rate, latency and other factors on which the one or more embodiments improve. There may further be an optional network functionality for reconfiguring the OTT connection 1550 between the host computer 1510 and UE 1530, in response to variations in the measurement results. The measurement procedure and/or the network functionality for reconfiguring the OTT connection 1550 may be implemented in the software 1511 of the host computer 1510 or in the software 1531 of the UE 1530, or both. In embodiments, sensors (not shown) may be deployed in or in association with communication devices through which the OTT connection 1550 passes; the sensors may participate in the measurement procedure by supplying values of the monitored quantities exemplified above, or supplying values of other physical quantities from which software 1511, 1531 may compute or estimate the monitored quantities. The reconfiguring of the OTT connection 1550 may include message format, retransmission settings, preferred routing etc.; the reconfiguring need not affect the base station 1520, and it may be unknown or imperceptible to the base station 1520. Such procedures and functionalities may be known and practiced in the art. In certain embodiments, measurements may involve proprietary UE signaling facilitating the host computer's 1510 measurements of throughput, propagation times, latency and the like. The measurements may be implemented in that the software 1511, 1531 causes messages to be transmitted, in particular empty or ‘dummy’ messages, using the OTT connection 1550 while it monitors propagation times, errors etc.

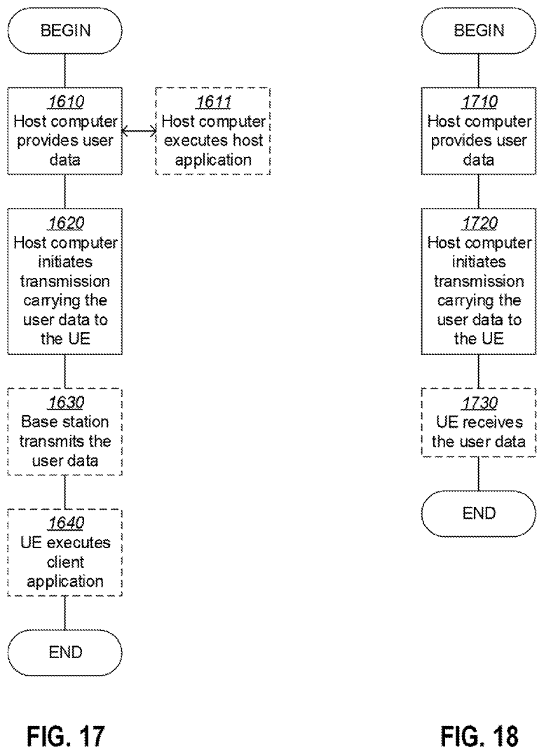

FIG. 17 is a flowchart illustrating a method implemented in a communication system, in accordance with one embodiment. The communication system includes a host computer, a base station such as an AP STA, and a UE such as a Non-AP STA which may be those described with reference to FIGS. 15 and 16. For simplicity of the present disclosure, only drawing references to FIG. 17 will be included in this section. In a first action 1610 of the method, the host computer provides user data. In an optional subaction 1611 of the first action 1610, the host computer provides the user data by executing a host application. In a second action 1620, the host computer initiates a transmission carrying the user data to the UE. In an optional third action 1630, the base station transmits to the UE the user data which was carried in the transmission that the host computer initiated, in accordance with the teachings of the embodiments described throughout this disclosure. In an optional fourth action 1640, the UE executes a client application associated with the host application executed by the host computer.

FIG. 18 is a flowchart illustrating a method implemented in a communication system, in accordance with one embodiment. The communication system includes a host computer, a base station such as an AP STA, and a UE such as a Non-AP STA which may be those described with reference to FIGS. 15 and 16. For simplicity of the present disclosure, only drawing references to FIG. 18 will be included in this section. In a first action 1710 of the method, the host computer provides user data. In an optional subaction (not shown) the host computer provides the user data by executing a host application. In a second action 1720, the host computer initiates a transmission carrying the user data to the UE. The transmission may pass via the base station, in accordance with the teachings of the embodiments described throughout this disclosure. In an optional third action 1730, the UE receives the user data carried in the transmission.

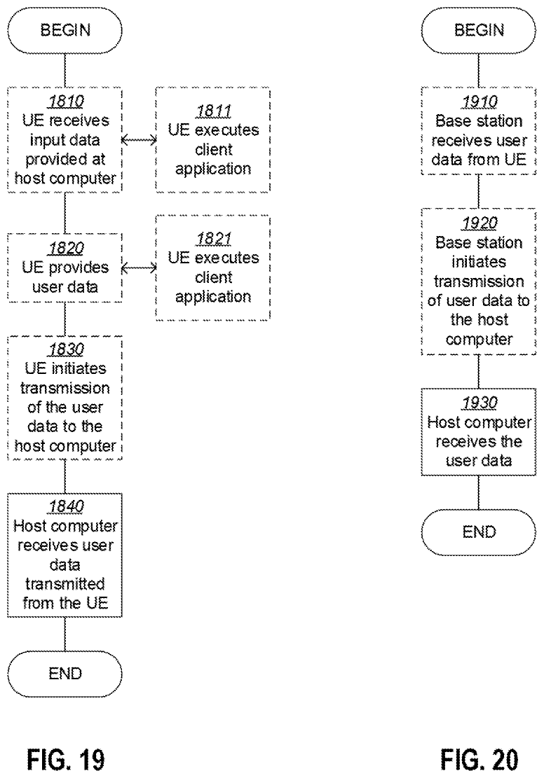

FIG. 19 is a flowchart illustrating a method implemented in a communication system, in accordance with one embodiment. The communication system includes a host computer, a base station such as an AP STA, and a UE such as a Non-AP STA which may be those described with reference to FIGS. 15 and 16. For simplicity of the present disclosure, only drawing references to FIG. 19 will be included in this section. In an optional first action 1810 of the method, the UE receives input data provided by the host computer. Additionally or alternatively, in an optional second action 1820, the UE provides user data. In an optional subaction 1821 of the second action 1820, the UE provides the user data by executing a client application. In a further optional subaction 1811 of the first action 1810, the UE executes a client application which provides the user data in reaction to the received input data provided by the host computer. In providing the user data, the executed client application may further consider user input received from the user. Regardless of the specific manner in which the user data was provided, the UE initiates, in an optional third subaction 1830, transmission of the user data to the host computer. In a fourth action 1840 of the method, the host computer receives the user data transmitted from the UE, in accordance with the teachings of the embodiments described throughout this disclosure.

FIG. 20 is a flowchart illustrating a method implemented in a communication system, in accordance with one embodiment. The communication system includes a host computer, a base station such as a AP STA, and a UE such as a Non-AP STA which may be those described with reference to FIGS. 15 and 16. For simplicity of the present disclosure, only drawing references to FIG. 20 will be included in this section. In an optional first action 1910 of the method, in accordance with the teachings of the embodiments described throughout this disclosure, the base station receives user data from the UE. In an optional second action 1920, the base station initiates transmission of the received user data to the host computer. In a third action 1930, the host computer receives the user data carried in the transmission initiated by the base station.

When using the word “comprise” or “comprising” it shall be interpreted as non-limiting, i.e. meaning “consist at least of”. When using the word “set” herein, it shall be interpreted as meaning “one or more”.

It will be appreciated that the foregoing description and the accompanying drawings represent non-limiting examples of the methods and apparatus taught herein. As such, the apparatus and techniques taught herein are not limited by the foregoing description and accompanying drawings. Instead, the embodiments herein are limited only by the following claims and their legal equivalents.

As used herein, the term “node”, or “network node”, may refer to one or more physical entities, such as devices, apparatuses, computers, servers or the like. This may mean that embodiments herein may be implemented in one physical entity. Alternatively, the embodiments herein may be implemented in a plurality of physical entities, such as an arrangement comprising said one or more physical entities, i.e. the embodiments may be implemented in a distributed manner, such as on a cloud system, which may comprise a set of server machines. In case of a cloud system, the term “node” may refer to a virtual machine, such as a container, virtual runtime environment, a software module or the like. The virtual machine may be assembled from hardware resources, such as memory, processing, network and storage resources, which may reside in different physical machines, e.g. in different computers.

1-38. (canceled)

39. A method, performed by an IP Multimedia Subsystem (IMS) core network node, for handling end-to-end (E2E) delays for voice calls in a communication network; wherein the communication network comprises a packet core network node, the IMS core network node, and a radio network node; wherein the radio network node is serving one or more User Equipment (UE); wherein the method comprises:
obtaining a Packet Delay Budget (PDB) for the IMS core network node;
estimating a packet delay related to a first voice call, wherein the packet delay is caused by the IMS core network;
determining a PDB for the packet core network node related to the first voice call, taking the estimated packet delay caused by the IMS core network into account; and
providing, to the packet core network node, the determined PDB for the packet core network node.

40. The method of claim 39, further comprising:
estimating a packet delay related to a second voice call, wherein the packet delay is caused by the IMS core network;
determining a packet delay budget for the packet core network node related to the second voice call, taking the estimated packet delay caused by the IMS core network into account; and
providing, to the packet core network node, the determined packet delay budget for the packet core network node.

41. The method of claim 39, wherein the estimated packet delay is a packet delay between an originating IMS access gateway (IMS AGW) and a terminating IMS AGW in the IMS core network.

42. The method of claim 40, wherein the estimated packet delay is estimated based on a time-stamp extracted from a Real-Time Transport Protocol (RTP) message and/or a Real-Time Control Protocol (RTCP) message associated with the first voice call and/or the second voice call.

43. The method of claim 40, wherein the estimated packet delay is estimated based on an indication of a specific geographic area related to the first voice call and/or the second voice calls.

44. The method of claim 40, wherein the determined packet delay budget is provided to the packet core network node at set-up of the first voice call and/or the second voice calls.

45. A method, performed by a packet core network node, for handling end-to-end (E2E) delays for voice calls in a communication network; wherein the communication network comprises the packet core network node, an IP Multimedia Subsystem (IMS) core network node, and the radio network node; wherein the radio network node is serving one or more User Equipment (UE); wherein the method comprises:
obtaining, from the IMS core network node, a Packet Delay Budget (PDB) for the packet core network node, wherein the packet delay relates to a first voice call;
estimating a packet delay related to a first voice call, wherein the packet delay is caused by the packet core network;
determining a PDB for the radio network node, wherein the PDB is related to the first voice call, taking the estimated packet delay caused by the packet core network into account; and
providing, to the radio network node, the determined PDB for the radio network node.

46. The method of claim 45, further comprising:
estimating a packet delay related to a second voice call, wherein the packet delay is caused by the packet core network;
determining a PDB for the radio network node related to the second voice call, taking the estimated packet delay caused by the packet core network into account; and
providing, to the radio network node, the determined PDB for the radio network node.

47. The method of claim 45, wherein the estimated packet delay is a packet delay between a serving packet core gateway and a remote packet core gateway in the packet core network.

48. The method of claim 46, wherein the estimated packet delay is estimated based on an indication of a specific geographic area related to the first voice call and/or the second voice call.

49. The method of claim 46, wherein the determined packet delay budget is provided to the radio network node at set-up of the first voice call and/or the second voice calls.

50. A method, performed by a radio network node, for handling end-to-end (E2E) delays for voice calls in a communication network; wherein the communication network comprises a packet core network, an IP Multimedia Subsystem (IMS) core network node, and the radio network node; wherein the radio network node is serving one or more User Equipment (UE); wherein the method comprises:
obtaining a Packet Delay Budget (PBD) for the radio network node, wherein the PDB is related to a first voice call associated with a first UE of the one or more UEs, wherein the packet delay budget takes packet delays caused by a core network into account;
scheduling the first voice call based on the obtained indication of the PDB associated with the first voice call.

51. The method of claim 50, further comprising:
obtaining a PDB for the radio network node, wherein the PDB is related to one or more second voice calls related to a second UE of the one or more UEs, wherein the packet delay budget takes packet delays caused by the core network into account;
scheduling the first voice call based on the obtained indication of the packet delay budgets associated with the first and the second voice calls.

52. The method of claim 51, wherein the first voice call is scheduled such that the E2E delay of the first and the one or more second voice calls is below a predetermined threshold.

53. The method of claim 50, wherein the PDB is obtained at set-up of the first voice call.

54. The method of claim 50, wherein the PDB is obtained during the first voice call.

55. An IP Multimedia Subsystem (IMS) core network node, for handling end-to-end (E2E) delays for voice calls in a communication network; wherein the communication network comprises a packet core network node, the IMS core network node, and a radio network node; wherein the radio network node is serving one or more User Equipment (UE), wherein the IMS core network node comprises:
processing circuitry;
memory containing instructions executable by the processing circuitry whereby the IMS core network node is operative to:
obtain a Packet Delay Budget (PDB) for the IMS core network node;
estimate a packet delay related to a first voice call, wherein the packet delay is caused by an IMS core network;
determine a PDB for the packet core network node related to the first voice call, taking the estimated packet delay caused by the IMS core network into account; and
provide, to the packet core network node, the determined PDB for the packet core network node.

56. The IMS core network node of claim 55, wherein the instructions are such that the IMS core network node is operative to:
estimate a packet delay related to a second voice call, wherein the packet delay is caused by the IMS core network;
determine a PDB for the packet core network node related to the second voice call, taking the estimated packet delay caused by the IMS core network into account; and
provide, to the packet core network node, the determined PDB for the packet core network node.

57. The IMS core network node of claim 55, wherein the instructions are such that the IMS core network node is operative to estimate the packet delay as a packet delay between a serving access gateway (AGW) and a remote AGW in the IMS core network.

58. The IMS core network node of claim 56, wherein the instructions are such that the IMS core network node is operative to estimate the packet delay based on a time-stamp extracted from a Real-Time Transport Protocol (RTP) message and/or a Real-Time Control Protocol (RTCP) message associated with the first voice call and/or the second voice call.
